(19) United States
(12) Patent Application Publication
(10) Pub. No.: US 2018/0131711 A1
(43) Pub. Date: May 10, 2018

(54) Protecting Computing Devices From Malicious Activity

(71) Applicant: QUALCOMM Incorporated, San Diego, CA (US)

(72) Inventors: Yin Chen, Campbell, CA (US); Ramin Samadani, Menlo Park, CA (US); Keen Yuun Sung, San Jose, CA (US)

(21) Appl. No.: 15/428,915

(22) Filed: Feb. 9, 2017

Related U.S. Application Data
(60) Provisional application No. 62/420,465, filed on Nov. 10, 2016.

(51) Int. Cl. H04L 29/06; H04L 12/26

(52) U.S. Cl. CPC H04L 63/1425; H04L 63/0245; H04L 69/22; H04L 43/0888

(57) ABSTRACT

Embodiments provide methods of protecting computing devices from malicious activity. A processor of a networking device may monitor network traffic flows of network computing devices and identify applications that are a source of the first network traffic flow. The processor may observe network traffic flows of identified source applications over time to determine normal network traffic flows of the source applications. The processor may then observe network traffic flows to detect when a source application is behaving anomalously based on associated network traffic flow characteristics deviating from normal network traffic flows of the source applications.

### RELATED APPLICATIONS

This application claims the benefit of priority to U.S. Provisional Patent Application No. 62/420,465 entitled “Visibility of Malicious Network Traffic” filed Nov. 10, 2016, the entire contents of which are incorporated herein by reference.

### BACKGROUND

The power and complexity computing devices (e.g., mobile electronic devices, cellular phones, tablets, laptops, etc.) provides increased access to information and communication resources. However, advancements in computing devices have also created new opportunities for malicious exploitation of such computing devices. For example, malicious software (“malware”) running on a computing device may exfiltrate information from the computing device or perform illicit activities on the network. Increasing malicious exploitation of computing devices calls for advanced methods of detecting and mitigating such exploitation of computing devices and communication networks.

Some computing devices have the capability of detecting malware by analyzing their behaviors. However, a network is likely to have many computing devices that lack such capabilities, and the presence of such devices may present an opportunity for exploitation of such devices or of the communication network by malware.

### SUMMARY

Various embodiments include methods that may be implemented on a processor of a network element for identifying compromised applications executing any computing devices within a network. Various embodiments may include monitoring network traffic flows to identify characteristics of the network traffic flows, identifying a source application that is a source of at least some of the network traffic flows by comparing the identified characteristics of the network traffic flows to network flow characteristics that have been determined to be associated with the identified source application, determining whether characteristics of network traffic flows identified as related to the source application match or are consistent with normal characteristics of network traffic flows associated with the identified source application, and determining that the identified source application is anomalous in response to determining that characteristics of the network traffic flows identified as related to the identified source application do not match or are inconsistent with the normal characteristics of network traffic flows of the identified source application.

Some embodiments may further include determining network flow characteristics associated with the identified source application by receiving a first network traffic flow of a monitoring computing device and a source application tag or other information identifying an application that is a source of the first network traffic flow, and determining one or more network flow characteristics that are associated with the identified source application of the first network traffic flow. Such embodiments may further include receiving a second network traffic flow from a non-monitoring computing device, determining a source application of the second network traffic flow by comparing characteristics of the second network traffic flow to the one or more network flow characteristics of the first network traffic flow determined to be associated with the source application, and determining normal characteristics of the source application by observing over a period of time network traffic flows having characteristics matching or corresponding to the one or more network flow characteristics associated with the identified source application.

Some embodiments may further include clustering network traffic flows based on characteristics of the network traffic flows matching or corresponding to the network flow characteristics associated with the identified source application.

In some embodiments, the characteristics of the network traffic flows may include information in packet headers of the network traffic flows. In some embodiments, the characteristics of the network traffic flows may include one or more traffic features of the first network traffic flows.

Some embodiments may further include determining network flow characteristics associated with the identified source application, and learning, by a semi-supervised application of the network device, associations of a source application tag with the network flow characteristics.

In some embodiments, identifying the source application that is a source of at least some of the network traffic flows by comparing the identified characteristics of the network traffic flows to network flow characteristics that have been determined to be associated with the identified source application may include comparing packet header information of the network traffic flows with packet header information associated with the source application, determining whether the packet header information of one or more of the network traffic flows matches or correlates to the packet header information associated with the source application, and associating the source application with one or more of the network traffic flows in response to determining that the packet header information of the one or more of the network traffic flows matches or correlates to the packet header information associated with the source application.

In some embodiments, identifying the source application of at least some of the network traffic flows by comparing the identified characteristics of the network traffic flows to network flow characteristics that have been determined to be associated with the identified source application may include comparing a traffic feature of the network traffic flows with a traffic feature associated with the source application, determining whether the traffic feature of one or more of the network traffic flows matches or correlates to the traffic feature associated with the source application, and associating the source application with one or more of the network traffic flows in response to determining that the traffic feature of the one or more of the network traffic flows matches or correlates to the traffic feature associated with the source application.

In some embodiments, identifying the source application that is the source of at least some of the network traffic flows by comparing the identified characteristics of the network traffic flows to network flow characteristics associated with the identified source application may include comparing packet header information of the network traffic flows with packet header information associated with the source application, comparing one or more traffic features of the network traffic flows with one or more traffic features associated with the source application, determining whether the packet header information and the one or more traffic features of the network traffic flows correlate to the packet header information and the one or more traffic features associated with the source application within a threshold degree of correlation, and associating the source application with one or more of the network traffic flows in response to determining that the packet header information and the one or more traffic features of the network traffic flows correlate to the packet header information and the one or more traffic features associated with the source application within the threshold degree of correlation.

Further embodiments may include a network device including a processor configured with processor-executable instructions to perform operations of the methods summarized above. Further embodiments may include a network device including means for performing functions of the methods summarized above. Further embodiments may include processor-readable storage media on which are stored processor executable instructions configured to cause a processor of a network device to perform operations of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system block diagram of a system suitable for use with various embodiments.

FIG. 2A is a process flow diagram illustrating an embodiment method for protecting computing devices from compromised applications according to various embodiments.

FIG. 2B is a process flow diagram illustrating an embodiment method for protecting computing devices from compromised applications according to various embodiments.

FIG. 2C is a process flow diagram illustrating an embodiment method for protecting computing devices from compromised applications according to various embodiments.

FIGS. 3A and 3B illustrate examples of traffic flow characteristics according to various embodiments.

FIG. 4A is a plot of packet interarrival times for two different network traffic flows according to various embodiments.

FIG. 4B is a comparison plot of packet interarrival times for two different network traffic flows at two different packet lengths according to various embodiments.

FIG. 4C is a comparison plot of packet densities for two different network traffic flows at two different packet lengths according to various embodiments.

FIG. 5 is a component block diagram of a computing device suitable for implementing various embodiments.

FIG. 6 is a component block diagram of a computing device suitable for implementing various embodiments.

FIG. 7 is a component block diagram of a server suitable for implementing various embodiments.

FIG. 8 is a component block diagram of a network device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide methods of using information from or related to network traffic flows to identify and/or characterize applications running on computing devices on a communication network. Various embodiments may apply machine learning techniques to learn associations of characteristics of network traffic flows, characterizations of the network traffic flows, and/or source applications of the network traffic flows.

The terms “computing device” and “mobile computing device” are used interchangeably herein to refer to any one or all of cellular telephones, smartphones, personal or mobile multi-media players, personal data assistants (PDAs), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

As used herein, the term “monitoring computing device” refers to a computing device that is configured to send information characterizing or identifying a network traffic flow and/or information characterizing or identifying an application of the computing device that is the source of a network traffic flow. Such information may include, for example, a source application tag that may indicate information about an application that is generating and/or receiving tagged network traffic flows. Such information may also include, for example, information identifying a particular application of the computing device as a source of, or the application originating and/or receiving, a particular network traffic flow.

As used herein, the term “non-monitoring computing device” refers to a computing device that is not configured to send information regarding applications that are the source of network communications.

Various embodiments are described herein using the term “server” to refer to any computing device capable of functioning as a server, such as a master exchange server, web server, mail server, document server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server-type functionality that can be implemented on a computing device thereby enabling it to function as an Internet server (e.g., an enterprise e-mail server) only to the extent necessary to provide the functionality described herein.

The term “network device” may be used in this application to refer to any computing device capable of forwarding packets between computing devices. Network devices may include computing devices such as routers, switches, base stations, gateways, network hubs, or any other type computing device configured to forward packets between computing devices. A network device may be a dedicated computing device or a computing device including a networking module (e.g., running an application which may cause the computing device to operate as a network device, such as a router). While various examples of network devices, such as routers, switches, base stations, etc., may be discussed herein to better illustrate aspects of various embodiments. However, those example network devices, such as routers, switches, base stations, etc., are merely used as examples, and other type computing device configured to forward packets between computing devices may be substituted for those example network devices in various embodiments.

In various embodiments, a network device may cluster network traffic flows for monitoring computing devices and non-monitoring computing devices to enable information from monitoring computing devices to be extended to non-monitoring computing devices.

In various embodiments, a communications network may include at least one monitoring computing device configured to provide information regarding source applications within or about network traffic flows being sent and/or received by that computing device. In various embodiments, monitoring computing devices may provide to the network device information identifying a source application (i.e., the “identified source application”) of a network traffic flow from the monitoring computing device. For example, a monitoring computing device may provide information identifying a particular application (e.g., a particular streaming media application, messaging application, browsing application, game application, and the like) as the source application of a particular network traffic flow. In some embodiments, a monitoring computing device may provide the information identifying the source application in the packet header of network traffic from the computing device. In some embodiments, a monitoring computing device may provide information identifying source applications in out of band message to the network device.

In various embodiments, the processor of the network device may determine one or more characteristics of a traffic flow from a computing device that are associated with an identified source application, such as one or more traffic flows of one or more monitoring computing devices and/or one or more non-monitoring computing devices. The traffic flow characteristics that may be determined to be associated with an identified source application may include information obtained directly from individual traffic packets (referred to as “intrinsic” characteristics), and information obtained by observing tagged packets over time for patterns in timing, volume, size, etc. of related communication packets (referred to as “extrinsic” characteristics).

Intrinsic characteristics obtained from individual packets of a traffic flow include information within the packet headers. Such intrinsic characteristics that may be determined to be associated with an identified source application may include one or more of an identifier (ID) of the computing device sending and/or receiving packets of the traffic flow (e.g., the computing device's MAC ID), a source Internet protocol (IP) address of the traffic flow, a source port of the traffic flow, a destination IP address of the traffic flow, and a destination port of the traffic flow. Intrinsic information may also include the time that a particular packet is sent via the network. The processor of the network device may determine such intrinsic traffic flow characteristics by performing packet header inspection of packets in the network traffic flows that are from or related to an identified source application. Inspection of the packet headers may enable the network device to handle both non-encrypted and encrypted network traffic flows in various embodiments.

Extrinsic traffic flow characteristics that may be determined to be associated with an identified source application may be obtained by the processor of the network device by observing tagged packets (i.e., packets including or associated with a source application tag or other information identifying the source application of the network traffic flow), and any packets received in response over an observational period of time to identify common features or patterns in such traffic flows. Examples of extrinsic traffic flow characteristics that may be determined to be associated with an identified source application may include one or more of packet size, packet volumes, packet interarrival times, packet lengths, packet length densities, session handshake patterns, messaging patterns, and packet statistics, such as mean packet size, interquartile range (IQR), and decomposition type (Wavelet, Fourier, etc.). In various embodiments, the network device may observe a plurality of packets from a network traffic flow that are from or related to an identified source application, and may perform one or more analyses on the plurality packets to determine one or more traffic flow characteristics associated with (or characteristic of) the identified source application.

In various embodiments, a semi-supervised application on the network device may learn to associate such intrinsic and extrinsic traffic flow characteristics with a characterization or description of a network traffic flow and/or identified source applications based on source application tags or other source identifying information received from monitoring computing devices. In various embodiments, the semi-supervised application may learn to associate traffic flow characteristics of traffic flows with source application identifying information from the monitoring computing devices (e.g., source application tags, information identifying a source application of a network traffic flow, etc.). In various embodiments, this association of information from the monitoring computing devices with certain network traffic flow characteristics may be achieved using machine learning by observing a large number of network traffic flows over time, as well as information about the network traffic flows provided by the monitoring computing devices.

In various embodiments, the processor of the network device may extend information learned about sources of traffic flows of the monitoring computing devices to characterize and monitor traffic flows of non-monitoring computing devices. Such learned associations may enable a network device to take actions to protect non-monitoring computing devices from applications that have been compromised and exhibit non-benign or malicious activities, to better analyze the sources of network traffic from monitoring and non-monitoring computing devices, and recognized when applications executing on networked computing devices are or have been compromised or taken over by non-benign software.

In some embodiments, the processor of the network device may use the learned associations of traffic flow characteristics and traffic flow characterizations or descriptions to associate information identifying a source application with characteristics of associated network traffic flows. In such embodiments, the network device may use the learned associations of the source applications with the traffic flow characteristics to determine the applications associated with network traffic of non-monitoring computing devices. This information may enable the network device to identify the various sources and volumes of network traffic associated with the various applications running on both monitoring and non-monitoring computing devices. This capability may enable the network device to generate more accurate network traffic flow information, including identifying the applications responsible for the traffic flows on the communication network.

In some embodiments, the processor of the network device may use the learned associations of information identifying a source application and network traffic flows to monitor network traffic flows of various applications of both monitoring and non-monitoring computing devices. In some embodiments, the processor of the network device may use the learned associations of information identifying a source application and network traffic flows to monitor network traffic flows of various applications of both monitoring and non-monitoring computing devices to identify when a source application of a traffic flows is a “compromised” application. A “compromised” application is application software that purports to be non-malicious software, and may perform expected or non-malicious functions, but also includes a non-benign or malicious software component. For example, a legitimate software application may be “hacked” and a non-benign or malicious software component added to the legitimate software application. In some embodiments, the network device may recognize that a source application of a monitored network traffic flow has been compromised by recognizing when network flow characteristics deviate from one or more learned network flow characteristics of the application. Various embodiments enable the network device to monitor network traffic flows of both monitoring and non-monitoring computing devices to detect deviations that may indicate an application has been compromised.

In various embodiments, the processor of the network device may cluster network traffic flows based at least in part on one or more determined traffic flow characteristics. In this manner, network traffic flows that carry similar data, provide similar services, or exhibit similar temporal or packet characteristics may be grouped together for analysis. In various embodiments, the processor of the network device may associate a source application tag for one network traffic flow in a cluster of network traffic flows with other (e.g., some other or all other) network traffic flows. In various embodiments, the processor of the network device may associate information identifying the source application of network traffic flows within a cluster of network traffic flows with other network traffic flows. In this manner, network traffic flows for non-monitoring computing devices may be clustered with network traffic flows from monitoring computing devices, and the processor of the network device may reduce hardware and software resources required for monitoring the various network traffic flows in the cluster. In some embodiments, network traffic flows for non-monitoring computing devices may be associated with source application tags and/or information identifying source applications based on the network traffic flows for non-monitoring computing devices being clustered with network traffic flows for monitoring computing devices.

In some embodiments, the clustered network traffic flows may share common traffic flow characteristics. For example, network traffic flows clustered with network traffic flows associated with information identifying a source application may be assumed to also be associated with the same source application.

In various embodiments, the processor of the network device may associate a source application tag and/or information identifying source applications for one network traffic flow in a cluster of network traffic flows with other network traffic flows based at least in part by applying a semi-supervised learning system. The semi-supervised learning system may be a computing device implemented pattern recognition technique that may operate automatically and free of human analyzer input, but that may optionally at times receive human analyzer input to update/modify/add/delete learned patterns.

The enhanced visibility into the various network traffic flows on the network for both monitoring computing devices and non-monitoring computing devices may enable more accurate management of network traffic flows. Various embodiments provide methods of using information from or related to network traffic flows to identify and/or characterize applications running on computing devices on a communication network. Various embodiments may apply machine learning capabilities to learn associations of characteristics of network traffic flows, characterizations of the network traffic flows, and/or source applications of the network traffic flows.

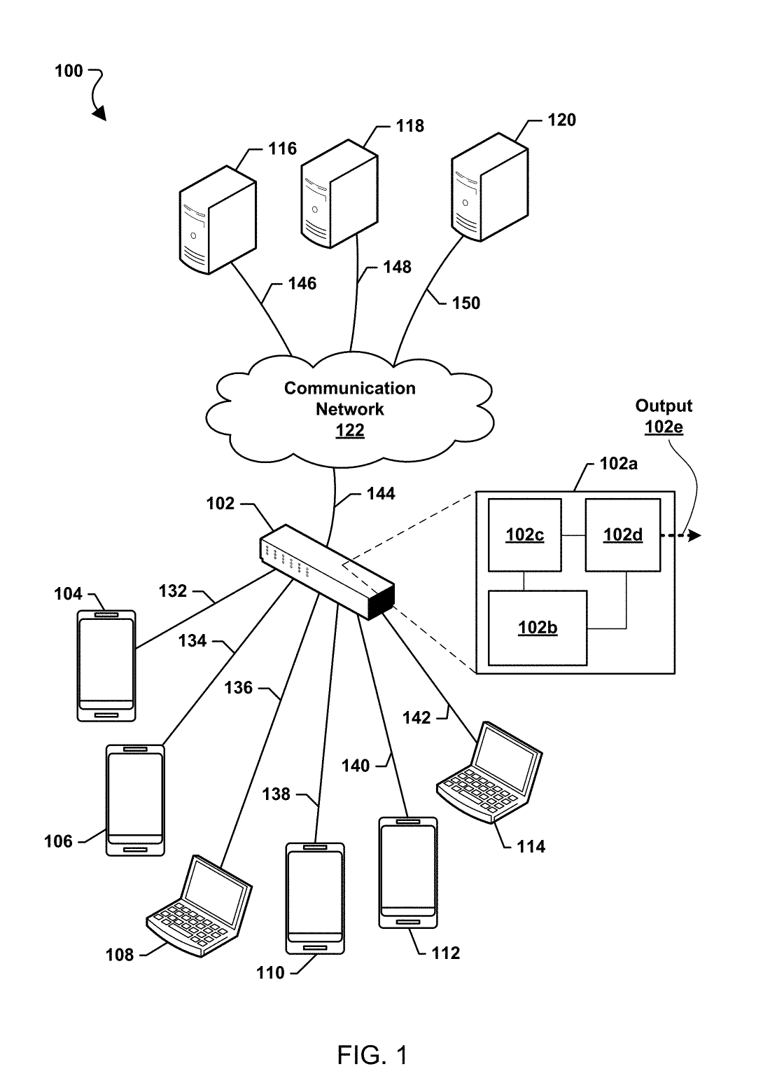

FIG. 1 illustrates a network system 100 suitable for use with various embodiments. The system 100 may include multiple devices, such as servers 116, 118, and 120, and computing devices 104, 106, 108, 110, 112, and 114. The computing devices 104-114 may communicate with a communication network 122 via a network device 102. The network device 102 may forward packets from or to the computing devices 104-114. In some embodiments, the network device 102 may establish a wide area network (WAN) type connection with the communication network 122 via one or more wired and/or wireless communication links 144, which may utilize a communication protocol such as Code Division Multiple Access (CDMA), Time Division Multiple Access (TDMA), Global System for Mobile Communications (GSM), Personal Communication Service (PCS), Third Generation (3G), Fourth Generation (4G), Long Term Evolution (LTE), Broadband Integrated Services Digital Network (B-ISDN), Digital Subscriber Line (DSL), or any other communication protocol. The network device 102 may also establish local area network (LAN) type connections with the computing devices 104-114 via one or more respective wired and/or wireless communication links 132-142, which may employ a communication protocol such as Code Division Multiple Access (CDMA), Time Division Multiple Access (TDMA), Global System for Mobile Communications (GSM), Personal Communication Service (PCS), Third Generation (3G), Fourth Generation (4G), Long Term Evolution (LTE), Bluetooth, Wi-Fi, Ethernet, or any other communication protocol. The network device 102 may communicate establish connections directly with the computing devices 104-114 or may communicate with the computing devices 104-114 indirectly through other devices, such as via base stations, access points, or other similar devices in communication with network device 102. In some embodiments, the network device 102 may be an element of a wireless communication network configured to facilitate communication between the computing devices 104-114 and the communication network 122.

The servers and 116-120 may communicate with the communication network 122 over respective communication links 146, 148, 150. The communication links 146, 148, 150 may employ a communication protocol similar to any of the communication protocols described above. The servers and 116-120 and the computing devices 104-114 may communicate information via network device 102 according to one or more transport protocols over the communication network 122. The servers 116-120 may be any type servers, such as web application servers that may host web applications, security hub devices that may manage security for groups of computing devices, such as computing devices 104-114, or any other type servers. Network traffic flows between the servers and 116-120 and computing devices 104-114 may be forwarded by the network device 102 such that the packets of the network traffic flows arrive at the intended destination devices, such as servers 116-120 and computing devices 104-114.

The network device 102 may include a network traffic flow module 102a. The network traffic flow module 102a may include a network traffic monitor 102b, a learning module 102c, and an analyzer module 102d. In various embodiments, the network traffic flow module 102a, the network traffic monitor 102b, the learning module 102c, and the analyzer module 102d may be implemented in the network device 102 in hardware, software, or a combination of hardware and software. In various embodiments, the network traffic flow module 102a may include, or may be a component of, a semi-supervised learning system that may be configured to learn associations of network traffic flow characteristics and information identifying characterizations of the network traffic flows and or characterizations of the source application of a network traffic flow. In various embodiments, each of the network traffic monitor 102b, the learning module 102c, and the analyzer module 102d may include, or may be a component of, the semi-supervised learning system.

In various embodiments, a monitoring computing device (e.g., the computing devices 104-114) may be configured to provide to the network device 102 information identifying a source application of a network traffic flow from the monitoring computing device. Monitoring computing devices may be configured to track applications that are generating network traffic and generate a separate or modified communication that provides that information to a network device 102. For example, a monitoring computing device may provide information identifying a particular application (e.g., a particular streaming media application, messaging application, browsing application, game application, and the like) as the source (i.e., the identified source application) of a particular network traffic flow. In some embodiments, the monitoring computing devices may be configured to include a source application tag in packet headers (e.g., as another field in the packet headers) that can be observed by the network device 102. In some embodiments, the monitoring computing devices may send information characterizing or identifying an application of the computing device that is the source of a network traffic flow to the network device 102 via another communication link, such as an “out-of-band” communication link.

One or more of the computing devices 104-114 may be a non-monitoring computing device that is not configured to send information to the network device 102 beyond the minimum information associated with network communications. Thus, the network device 102 will receive little or no information from non-monitoring computing device 104-114 characterizing or identifying a network traffic flow and/or information characterizing or identifying an application that is the source of a network traffic flow. In various embodiments, a portion of the computing devices 104-114 may be configured to operate as monitoring computing devices while another portion of the computing devices 104-114 may be non-monitoring computing devices (i.e., not configured to operate as monitoring computing devices).

In various embodiments, the processor of the network device 102 (e.g., the network traffic monitor 102b) may determine one or more characteristics of a traffic flow from the computing devices 104-114, such as one or more traffic flows of one or more monitoring computing devices and/or one or more non-monitoring computing devices. The traffic flow characteristics may include information from the packet header of a traffic flow, such as one or more of an identifier (ID) of the computing device sending and/or receiving packets of the traffic flow (e.g., the computing device's MAC ID), a source IP address of the traffic flow, a source port of the traffic flow, a destination IP address of the traffic flow, and a destination port of the traffic flow. The processor of the network device 102 may determine such traffic flow characteristics by performing packet header inspection of packets in the network device. Inspection of the packet headers may enable the network device to handle both non-encrypted and encrypted network traffic flows in various embodiments.

In various embodiments, the traffic flow characteristics may include one or more behaviors, characteristics, or features of the network traffic flows. In various embodiments, traffic flow features that may be determined by the processor of the network device 102 may include one or more of packet size, packet volumes, packet interarrival times, destination addresses, destination ports, packet lengths, packet length densities, session handshake patterns, messaging patterns, packet statistics (e.g., mean packet size, interquartile range (IQR), and decomposition type (Wavelet, Fourier, etc.)). In some embodiments, the network device may receive a plurality of packets from a network traffic flow and may perform one or more analyses on the plurality packets to determine one or more traffic flow characteristics.

In various embodiments, a semi-supervised application on the network device 102 (e.g., learning module 102c) may learn to associate traffic flow characteristics of traffic flows with a characterization or description of a network traffic flow and/or particular applications. In various embodiments, the semi-supervised application may learn to associate traffic flow characteristics of traffic flows with information from the monitoring computing devices (e.g., source application tags, information identifying a source application of a network traffic flow, etc.). In various embodiments, this association of information from the monitoring computing devices with certain network traffic flow characteristics may be achieved using machine learning by observing a large number of network traffic flows as well as information about the network traffic flows provided by the monitoring computing devices.

In various embodiments, the processor of the network device 102 (e.g., the analyzer module 102d) may extend information about traffic flows of the monitoring computing devices that is determined and/or received by the network device 102 to characterize and monitor traffic flows of non-monitoring computing devices. In some embodiments, the processor of the network device 102 (e.g., the analyzer module 102d) may use the learned associations of traffic flow characteristics and traffic flow characterizations or descriptions (e.g., learned by the learning module 102c) to associate a source application tag with a network traffic flow of a non-monitoring computing device. For example, the processor of the network device 102 may associate a source application tag with a network traffic flow by matching traffic flow information and a source application tag, based on one or more traffic flow characteristics. In some embodiments, the processor of the network device 102 may be configured to recognize applications that are the source of network traffic to and from non-monitoring computing devices by recognizing patterns in network traffic learned by observing network traffic flows including source application tags received from monitoring computing devices. In various embodiments, this information may enable the network device to monitor network traffic flows and identify sources of network traffic of both monitoring and non-monitoring computing devices. In various embodiments, the network traffic flow module 102a may provide as an output 102e the learned associations of traffic flow characteristics and traffic flow characterizations or descriptions, associations of a source application tag with a network traffic flow of a monitoring and/or non-monitoring computing device, and other information.

In some embodiments, the processor of the network device 102 (e.g., the analyzer module 102d) may use the learned associations of traffic flow characteristics and traffic flow characterizations or descriptions to associate information identifying a source application with a network traffic flow. In some embodiments, the network device 102 may use the learned association of the identified source applications with the traffic flow characteristics to determine applications associated with network traffic of non-monitoring computing devices. This information may enable the network device 102 to identify the various sources and volumes of traffic associated with the various applications running on both monitoring and non-monitoring computing devices, which may enable the network device 102 to generate more accurate network traffic flow information, including identifying the applications responsible for the traffic flows on the communication network. In various embodiments, the network traffic flow module 102a may provide as the output 102e the learned associations of the source applications with the traffic flow characteristics, the identification of the various sources and volumes of traffic, the more accurate network traffic phone information, and other information.

In some embodiments, the processor of the network device 102 may use the learned associations of information identifying a source application and network traffic flows to monitor network traffic flows of various applications of both monitoring and non-monitoring computing devices to identify when a source application of a traffic flows has been converted into a malicious application. In some embodiments, the processor of the network device 102 may use the learned associations of information identifying a source application and network traffic flows to monitor network traffic flows of various applications of both monitoring and non-monitoring computing devices to identify when a source application of a traffic flows is a “compromised” application.

In various embodiments, the processor of the network device 102 may cluster network traffic flows of the computing devices 104-114 based at least in part on one or more determined traffic flow characteristics. In this manner, network traffic flows that carry similar data or provide similar services may be grouped together. In various embodiments, the processor of the network device 102 may associate a source application tag for one network traffic flow in a cluster of network traffic flows with other (e.g., some other or all other) network traffic flows. In various embodiments, the processor of the network device 102 may associate information identifying the source application of network traffic flow in a cluster of network traffic flows with other network traffic flows. In this manner, network traffic flows for non-monitoring computing devices may be clustered with network traffic flows from monitoring computing devices, and the processor of the network device 102 may reduce hardware and software resources required for monitoring the various network traffic flows in the cluster. In some embodiments, network traffic flows for non-monitoring computing devices may be associated with source application tags and/or information identifying source applications based on the network traffic flows for non-monitoring computing devices being clustered with network traffic flows for monitoring computing devices.

In some embodiments, the clustered network traffic flows may share common traffic flow characteristics. For example, network traffic flows clustered with a network traffic flows associated with information identifying a source application may be assumed to also be associated with the same source application. In various embodiments, the processor of the network device 102 may associate a source application tag and/or information identifying source applications for one network traffic flow in a cluster of network traffic flows with other network traffic flows based at least in part by applying a semi-supervised learning system (e.g., the network traffic flow module 102a, the network traffic monitor 102b, the learning module 102c, and/or the analyzer module 102d). The semi-supervised learning system may be a computing device-implemented pattern recognition technique that may operate automatically, free of human analyzer input. In some embodiments, the semi-supervised learning system may at times receive human analyzer input to update/modify/add/delete learned patterns.

In various embodiments, the processor of the network device 102 may send an indication of all network traffic flows associated with a source application tag and/or information identifying source applications to another device, such as a security hub managing security for those network traffic flows. In some embodiments, the security hub may be a component of the network device 102. In some embodiments, the security hub may be another element of the communication system 100.

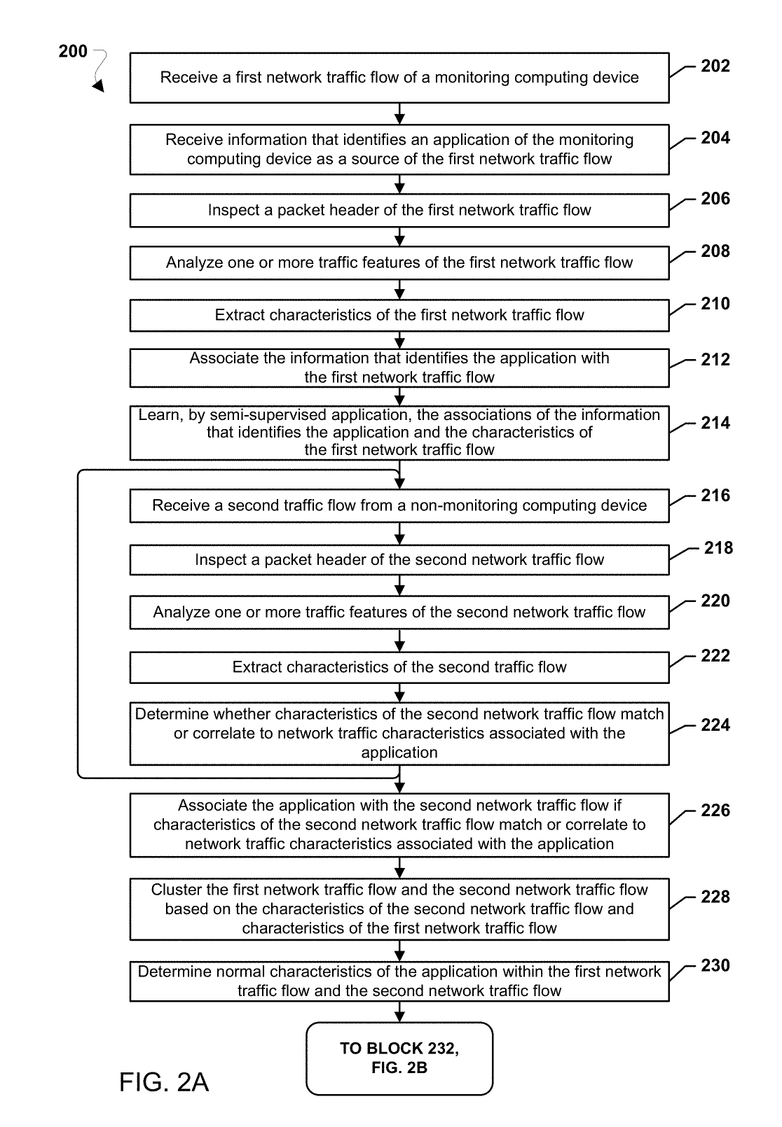

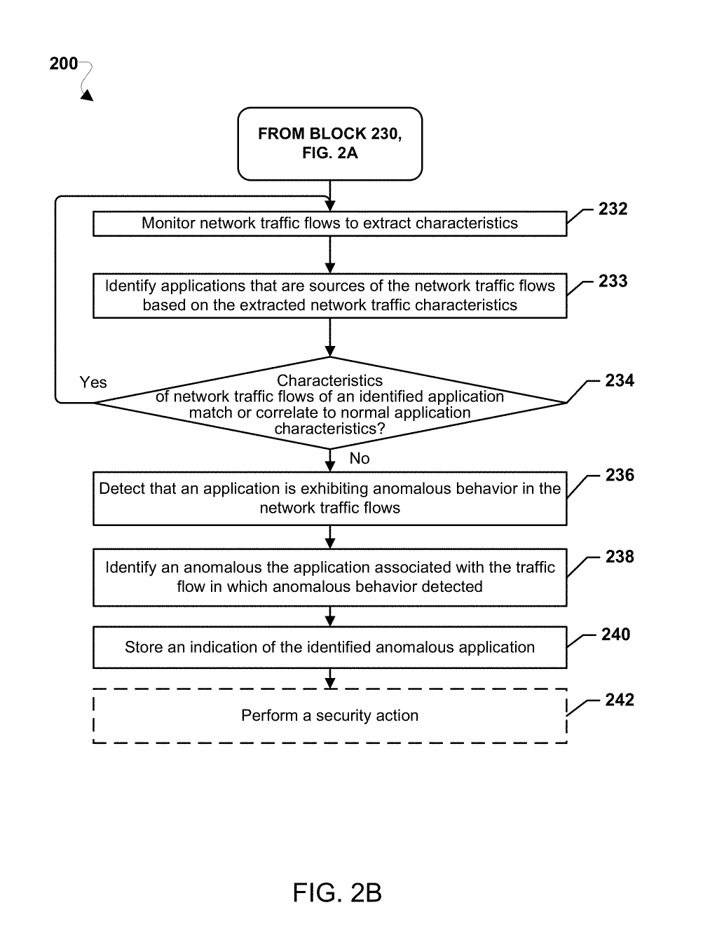

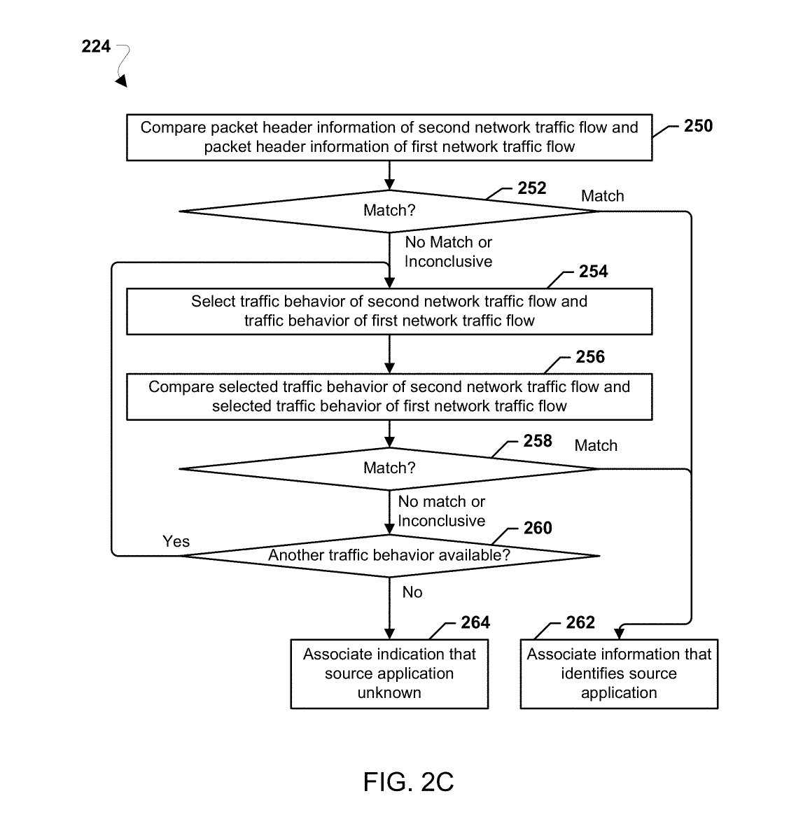

FIGS. 2A and 2B illustrate a method 200 for protecting computing devices from applications that become compromised with non-benign or malicious activity according to various embodiments. With reference to FIGS. 1-2B, the method 200 may be implemented by a processor of a network device 102.

In block 202, the processor of the network device 102 may receive a first network traffic flow for a monitoring computing device. For example, the processor of the network device 102 may receive the first network traffic flow to and/or from one of the computing devices 104-114 that is configured to operate as a monitoring computing device.

In block 204, the processor of the network device 102 may receive a source application tag or other source of information that identifies an application of a monitoring computing device that is the source of the first network traffic flow. In some embodiments, a source application tag or similar form of information may identify a type of application, such as a streaming media application, a messaging application, a browsing application, game application, and the like. In some embodiments, the source application information may identify a specific application (e.g., a specific streaming media application, messaging application, etc.). In some embodiments, the information that identifies the source application (e.g., a source application tag included within packet headers) may be text information, a numeric or alphanumeric code, a reference to a data structure that correlates the reference to an application (such as a lookup table), or other information that identifies the application.

In some embodiments, source application tag or other information that identifies the application may be sent in an out of band message, such as an overhead signaling message, from a monitoring computing device to the network device 102.

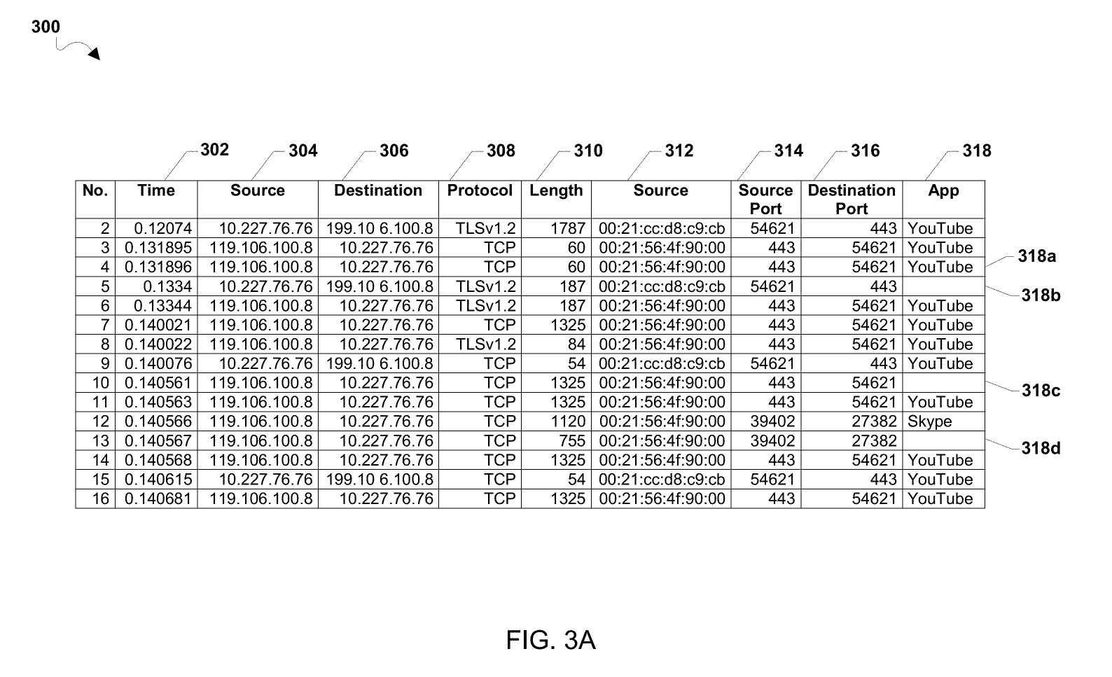

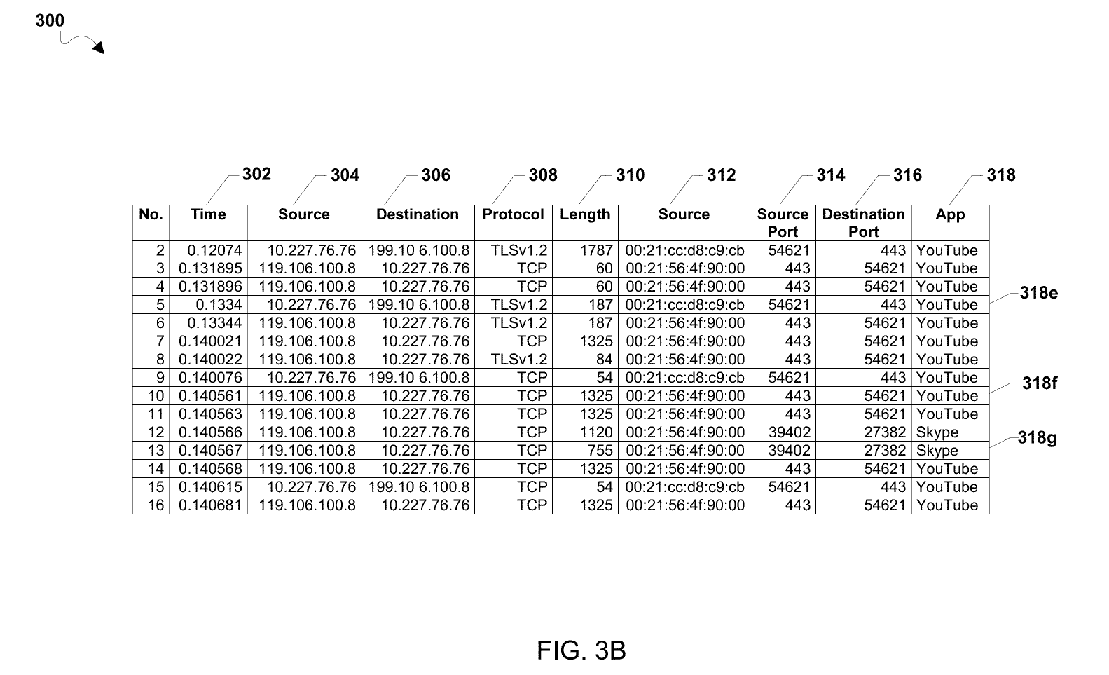

The processor of the network device 102 may determine one or more characteristics of a traffic flow from a computing device, such as one or more traffic flows of one or more monitoring computing devices 104-114 and/or one or more non-monitoring computing devices. In block 206, the processor of the network device 102 may inspect the packet header of the first network traffic flow to observe intrinsic traffic flow characteristics of individual packets within the flow associated with an identified source application. The intrinsic traffic flow characteristics may include information from the packet header of a traffic flow, such as one or more of an identifier (ID) of the computing device sending and/or receiving packets of the traffic flow (e.g., the computing device's MAC ID), a source IP address of the traffic flow, a source port of the traffic flow, a destination IP address of the traffic flow, and a destination port of the traffic flow. The processor of the network device 102 may determine such intrinsic traffic flow characteristics associated with an identified source application by performing packet header inspection of packets in the network traffic flows. Inspection of the packet headers may enable the network device to handle both non-encrypted and encrypted network traffic flows in various embodiments. In various embodiments, the processor of the network device 102 may inspect packet headers of non-encrypted and/or encrypted network traffic flows. In some embodiments, the processor of the network device 102 may store packet header information in a data structure configured to enable rapid access to the various packet header data, as further described with reference to traffic flow characteristics 300 illustrated in FIG. 3.

In block 208, the processor of the network device 102 may analyze a plurality of packets of the first network traffic flow associated with an identified source application for one or more extrinsic traffic characteristics. In various embodiments, extrinsic traffic flow characteristics may include one or more behaviors, characteristics, or features of the network traffic flows. In various embodiments, extrinsic traffic flow characteristics that may be determined by the processor of the network device 102 in block 208 may include one or more of packet size, packet volumes, packet interarrival times, packet lengths, packet length densities, session handshake patterns, messaging patterns, and packet statistics (e.g., mean packet size, interquartile range (IQR), and decomposition type (Wavelet, Fourier, etc.)).

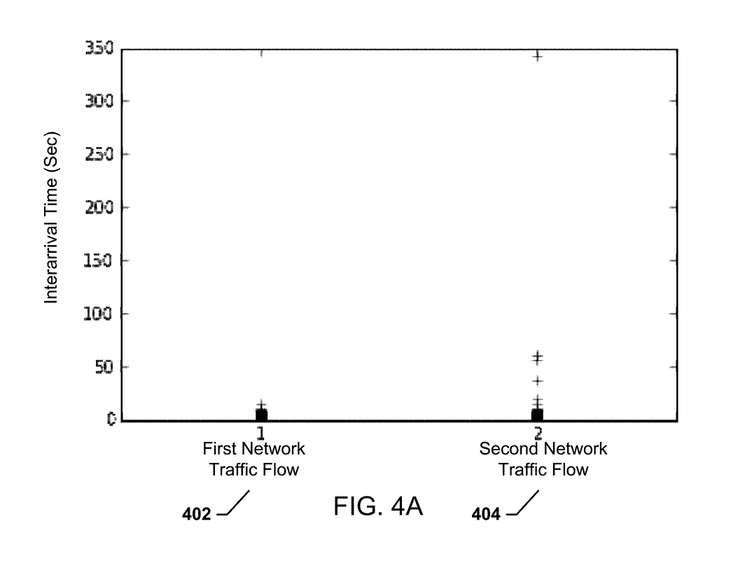

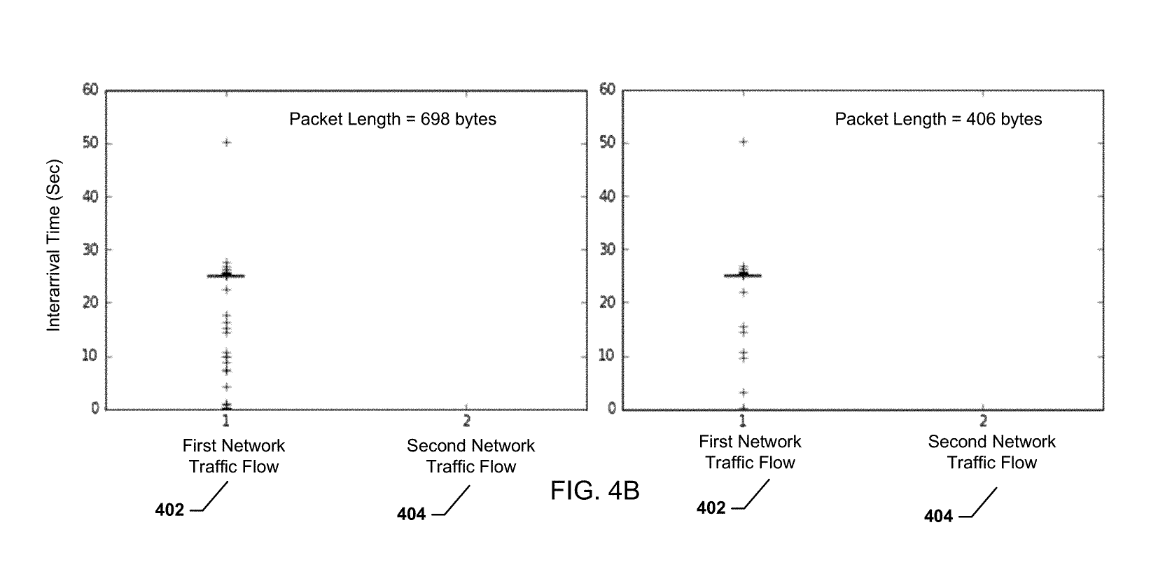

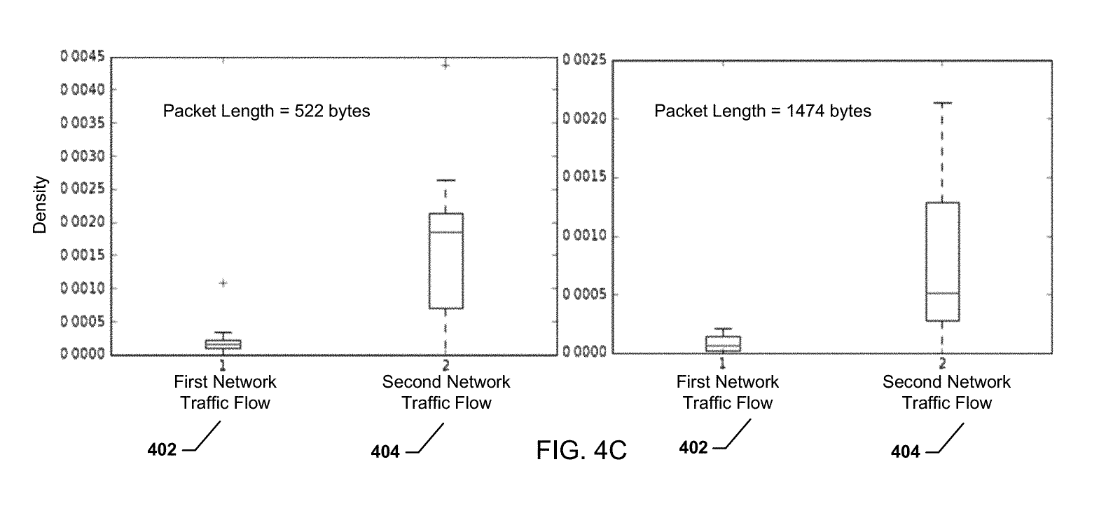

In block 210, the processor of the network device 102 may extract the characteristics of the first network traffic flow that are associated with identified source applications. In some embodiments, the extracted characteristics of the first network traffic flow that may be associated with identified source applications may include both intrinsic characteristics obtained from the inspection of packet headers of packets in the first network traffic flow, and extrinsic characteristics obtained from the analysis of the one or more traffic patterns observable within the first network traffic flow. FIGS. 4A, 4B, and 4C illustrate examples of extrinsic characteristics or features of the network traffic flows that may be observed and extracted by the processor in block 210. As further described, the extrinsic traffic flow characteristics illustrated in FIGS. 4A, 4B, and 4C may be used singularly, or in combinations, and may enable network traffic flows to be compared with one another based on common traffic flow features or distinguished from one another based on different traffic flow features.

In block 212, the processor of the network device 102 may associate the source application tag or other information that identifies the application with the first network traffic flow. In various embodiments, the processor may associate the source application tag or other information that identifies the application with characteristics of the network traffic flow associated with the source application tag or other information that identifies the source application. In some embodiments, the processor of the network device 102 may associate the source application tag or other information that identifies the application with one or more characteristics of the first network traffic flow extracted in block 210.

In block 214, a semi-supervised application may learn the associations of the source application tag or other information that identifies the application and certain characteristics of the first network traffic flow. In various embodiments, the semi-supervised application on the network device 102 may learn to associate one or more traffic flow characteristics of traffic flows with the source application tag or other information that identifies the application. In various embodiments, this association of the source application tag or other information that identifies the application with one or more network traffic flow characteristics may be achieved using machine learning by observing a large number of network traffic flows in combination with information about the network traffic flows provided by the monitoring computing devices.

In block 216, the processor of the network device 102 may receive a second traffic flow from a non-monitoring computing device.

In block 218, the processor of the network device 102 may inspect packet headers of the second network traffic flow. In various embodiments, the operations of block 218 may be similar to the operations of block 206.

In block 220, the processor of the network device 102 may analyze one or more traffic features of the second network traffic flow. In various embodiments, the operations of block 220 may be similar to the operations of block 208.

In block 222, the processor of the network device 102 may extract characteristics of the second traffic flow. In some embodiments, the extracted characteristics of the second network traffic flow may be based on one or more of the inspection of a packet header of the second network traffic flow and/or an analysis of one or more traffic behaviors of the second network traffic flow.

In block 224, the processor of the network device 102 may determine whether the extracted characteristics of the second traffic flow match or are substantially similar to the learned associations of the source application tag or other information that identifies the application and characteristics of the associated first network traffic flow. In some embodiments, the semi-supervised learning application may determine whether the extracted characteristics of the second traffic flow match or are substantially similar to the learned one or more characteristics of the associated first network traffic flow associated a source application tag or other information that identifies the source application.

In block 226, the processor of the network device 102 may associate the source application tag or other information that identifies the source application with the second network traffic flow if the characteristics of the second network traffic flow match or are similar to the learned one or more characteristics of the first network traffic flow associated with the identified source application. In some embodiments, the processor of the network device 102 may associate the source application or the source application tag in the first network traffic flow with the second network traffic flow when there is a match or substantial similarity between the flows in the learned associations.

In block 228, the processor of the network device 102 may cluster the first network traffic flow and the second network traffic flow based on the characteristics of the second network traffic flow and the one or more characteristics associated with an identified source application of the first network traffic flow. In this manner, the processor of the network device 102 may group together network traffic flows that carry similar data or provide similar services. In various embodiments, the processor of the network device 102 may associate a source application tag or other information that identifies a source application for one network traffic flow in a cluster of network traffic flows with other (e.g., some other or all other) network traffic flows. Clustering network traffic flows for non-monitoring computing devices with network traffic flows from monitoring computing devices may reduce hardware and software resources required for monitoring the various network traffic flows in the cluster. In some embodiments, network traffic flows for non-monitoring computing devices may be associated with source application tags and/or information identifying source applications based on the network traffic flows for non-monitoring computing devices being clustered with network traffic flows for monitoring computing devices.

In some embodiments, the clustered network traffic flows may share common traffic flow characteristics. For example, network traffic flows clustered with a network traffic flow associated with a source application tag may be assumed to also be associated with the same source application. In various embodiments, the processor of the network device 102 may associate a source application tag and/or information identifying source applications for one network traffic flow in a cluster of network traffic flows with other network traffic flows based at least in part by applying a semi-supervised learning system. The semi-supervised learning system may be a computing device-implemented pattern recognition technique that may operate automatically and free of human analyzer input, but that may optionally at times receive human analyzer input to update/modify/add/delete learned patterns.

In block 230, the processor of the network device 102 may determine normal characteristics of each application within the first network traffic flow and the second network traffic flow. Normal network traffic flow characteristics of an application may include one or more of normal traffic volume, packet size(s), packet volumes, interarrival times, destination addresses, destination ports, packet lengths, packet length densities, session handshake patterns, messaging patterns, packet statistics (e.g., mean packet size, interquartile range (IQR), and decomposition type (Wavelet, Fourier, etc.)). In some embodiments, the network device may receive a plurality of packets from a network traffic flow and may perform one or more analyses on the plurality packets to determine one or more normal network traffic flow characteristics. In some embodiments, the processor of the network device may determine the normal network traffic flow characteristic(s) over time, such as an aggregate, an average, or another determination of network traffic flow characteristics over a period of time. The period of time may change from time to time, such as a moving window or another such technique.

With normal characteristics of network traffic flows from various applications established in block 230, the network device 102 may monitor network traffic flows to recognize when an application becomes compromised with non-benign or malicious functionality revealed in a change in network traffic associated with the application. This may involve monitoring network traffic flow characteristics to identify applications that are the source of various groups of network traffic flows, and then evaluating whether the traffic flow characteristics match or are consistent with normal characteristics of network traffic flows of the identified applications.

Referring to FIG. 2B, in block 232, the processor of the network device 102 may monitor subsequent network traffic flows, extracting one or more characteristics of the network traffic flows. In some embodiments, monitoring the network traffic flows may include inspecting a packet header and/or analyzing one or more traffic features of the network traffic flows over a period of time.

In block 233, the processor of the network device 102 may identify the applications that are the sources of the network traffic flows by comparing the extracted traffic flow characteristics to traffic flow characteristics associated with various applications. The operations in block 233 may be similar to the operations in block 226 as described.

In determination block 234, the processor of the network device 102 may determine whether characteristics of the network traffic flows associated with one or more identified applications match or correlate to the normal characteristics of the one or more applications. For example, the processor of the network device 102 may determine whether the extracted characteristics of the network traffic flows identified as associated with (i.e., flowing from or to) a particular application match or are substantially similar to normal characteristics of the network traffic from/to that source application. In some embodiments, the semi-supervised learning application may determine whether the extracted characteristics of the network traffic flows match or are substantially similar to normal characteristics of the identified application. In some embodiments, the processor of the network device 102 may determine whether one or more characteristics of traffic flows from/to an application, such as traffic volume, packet size(s), packet volumes, interarrival times, destination addresses, destination ports, packet lengths, packet length densities, session handshake patterns, messaging patterns, packet statistics (e.g., mean packet size, interquartile range (IQR), and decomposition type (Wavelet, Fourier, etc.)), deviates from a normal value or normal range for such characteristics of traffic flows from/to the application.

In response to determining that the characteristics of the network traffic flows associated with all of the identified applications match the normal characteristics of the corresponding application (i.e., determination block 234=“Yes”), the processor of the network device 102 may continue to monitor the network traffic flows in block 232.

In response to determining that the characteristics of the network traffic flows associated with one or more of the identified applications do not match the normal characteristics of the application (i.e., determination block 234=“No”), the processor of the network device 102 may detect that an anomalous behavior is occurring in one of the network traffic flows in block 236.

In block 238, the processor of the network device 102 may identify the source application associated with the identified anomalous traffic flow. In some embodiments, this may be accomplished by determining the application that exhibits network traffic flows with characteristics most similar to the observed anomalous traffic flows. In some embodiments, the operations in blocks 236 and 238 may be performed in a single operation.

In block 240, the processor of the network device 102 may store an indication of the identified anomalous application. In some embodiments, the processor of the network device 102 may associate the indication with a source application tag.

In optional block 242, the processor of the network device 100 to may perform a security action. For example, the processor of the network device 102 may send to one or more of the monitoring communication devices and the non-monitoring communication device an indication of the identified anomalous application. In some embodiments, the processor of the network device 100 to may send the indication to a communication device (whether monitoring or non-monitoring) to enable the communication device to take appropriate action to remedy the anomalous behavior and/or anomalous application.

As another example, the processor of the network device 102 may send an indication of all network traffic flows associated with a malicious activity tag and/or information identifying source applications to another device, such as a security hub managing security for those network traffic flows. In various embodiments, the security hub may be able to take an action to handle non-benign or malicious network traffic flows for non-monitoring computing devices, as well as monitoring computing devices. This may be enabled by associating source application tags and/or information identifying source applications with network traffic flows. For example, the security hub may be configured to prioritize suspicious network flows for deeper analysis and the prioritization may be based at least in part on any malicious activity tags received by the security hub.

FIG. 2C illustrates an example of operations that may be performed as part of block 224 of the method 200. With reference to FIGS. 1-2B, the operations of block 224 may be implemented by a processor of a network device 102.

In block 250, the processor of the network device 102 may compare packet header information of the second network traffic flow with packet header information that has been associated with a particular source application by observing packet headers of the first network traffic flow. The compared packet header information may include one or more of an identifier (ID) of the computing device sending and/or receiving packets of the traffic flow (e.g., the computing device's MAC ID), a source IP address of the traffic flow, a source port of the traffic flow, a destination IP address of the traffic flow, and a destination port of the traffic flow. The processor of the network device 102 may compare the packet header information rapidly, which may enable the processor of the network device 102 to quickly make an initial determination regarding the comparison.

In determination block 252, the processor of the network device 102 may determine whether the packet header information of the second network traffic flow matches or correlates to packet header information that has been associated with a particular source application. In some embodiments, the processor may determine whether the packet header information matches packet header information associated with a particular source application. In some embodiments, the processor may determine whether the packet header information correlates to (i.e., is similar to or has aspects in common with) packet header information associated with a particular source application within one or more ranges, thresholds, or other criteria. Thus, the processor need not require an exact match of any information in the packet headers of the first and second network traffic flows.

In response to determining that the packet header information of the second network traffic flow matches or correlates to packet header information associated with a particular source application (i.e., determination block 252=“Match”), the processor of the network device 102 may associate a source application tag or other information identifying a source application with the second network traffic flow in block 262.

In response to determining that the packet header information of the second network traffic flow does not match or correlate to packet header information associated with a particular source application (i.e., determination block 252=“No Match”), or in response to determining that the comparison is inconclusive because the processor of the network device 102 is unable to make a clear determination regarding whether the packet header information of the second network traffic flows matches packet header information associated with a particular source application (i.e., determination block 252=“No Match or Inconclusive”), the processor of the network traffic device may select a traffic feature of the second network traffic flow and traffic feature associated with a particular source application flow in block 254.

In block 256, the processor of the network device 102 may compare the selected traffic feature of the second network traffic flow with the selected traffic feature associated with a particular source application. For example, the processor of the network device 102 may compare interarrival times of related packets in the second network traffic flow to a range of interarrival times that the network device 102 has associated with a particular source application.

In operation, comparison of observable features of network traffic flows to traffic features associated with a particular source application may require processing time, because the processor of the network device 102 receives numerous packets of the second traffic flows in order to observe and recognize various traffic flow characteristics that are time dependent (e.g., interarrival times, frequency, volume, etc.). As described, traffic flow characteristics that may be determined by the processor of the network device 102 may include one or more of packet size, packet volumes, interarrival times of packets, packet lengths, packet length densities, session handshake patterns, messaging patterns, packet statistics (e.g., mean packet size, interquartile range (IQR), and decomposition type (Wavelet, Fourier, etc.)).

In determination block 258, the processor of the network device 102 may determine whether the selected traffic feature of the second network traffic flow matches or correlates to the selected traffic feature associated with a particular source application. In some embodiments, the processor may determine whether the selected traffic feature of the second network traffic flow matches the selected traffic feature associated with a particular source application. In some embodiments, the processor may determine whether the selected traffic feature of the second network traffic flow correlates to (i.e., is similar to or has aspects in common with) the selected traffic feature associated with a particular source application within one or more ranges, thresholds, or other criteria.

In determination block 258, the processor may evaluate multiple traffic features in the second traffic flow that have been associated with a particular source application, as well as intrinsic characteristics, to determine whether a combination of traffic features and characteristics correlate (i.e., are similar enough) to packet header information and traffic features and characteristics associated with a particular source application (e.g., within a threshold level of similarity or probability) to warrant classification as associated with a particular source application. This determination 258 may compare a degree of correlation between the packet header information and a combination of traffic features of the second traffic flow with packet header information and traffic features and characteristics associated with a particular source application to a threshold degree of correlation.

In response to determining that the selected traffic feature of the second network traffic flow matches or correlates to the selected traffic feature associated with a particular source application (i.e., determination block 258=“Match”), the processor of the network device 102 may associate the source application tag or other information identifying a source application with the second network traffic flow in block 262.

In response to determining that the selected traffic feature of the second network traffic flow does not match or correlate to the selected traffic feature associated with a particular source application (i.e., determination block 258=“No Match”), or in response to determining that the comparison is inconclusive because the processor of the network device 102 may be unable to make a clear determination regarding whether the selected traffic feature of the second network traffic flow matches or correlates to the selected traffic behavior of the first network traffic flow (i.e., determination block 258=“No Match or Inconclusive”), the processor of the network traffic device may determine whether another traffic feature associated with a particular source application is available for comparison in determination block 260.

In response to determining that another traffic feature associated with a particular source application is available for comparison (i.e., determination block 260=“Yes”), the processor of the network device 102 may select another traffic feature to be observed in the second network traffic flow and compared to a traffic feature associated with a particular source application in block 254.

In response to determining that another traffic feature associated with a particular source application is not available for comparison (i.e., determination block 260=“No”), the processor of the network device 102 may associate with the second network traffic flow an indication that the source application is unknown in block 264.

FIGS. 3A and 3B illustrate examples of intrinsic traffic flow characteristics 300 according to some embodiments. With reference to FIGS. 1-3B, a processor of a network device 102 may inspect a packet header of the first and/or second network traffic flows to extract the traffic flow characteristics 300. In some embodiments, the processor may store the traffic flow characteristics 300 in a memory of the network device available to the processor. In some embodiments, the processor may cluster packet header information by recording the number of packets observed within a traffic flow having packet header information of a particular type (e.g., particular destination address, port number, etc.).

In some embodiments, the traffic flow characteristics 300 may include a time stamp 302 of each packet, a source 304 of the network traffic, a destination 306 of the network traffic, a protocol 308 of the network traffic, a packet length 310 of the network traffic, a source device ID 312 of the network traffic, a source port 314 of the network traffic, and a destination port 316 of the network traffic. A monitoring computing device may include within packet headers an indicator of a type application 318 that is the source of each network packet, such as a source application tag. The application indicators 318 may be based on the information that identifies the source application of the particular traffic flow. For example, application indicator 318a indicates that the application “YouTube” is the source application of that particular network traffic flow. In some embodiments, a monitoring computing device 104-114 may send the application indicator 318a to the network device 102.

Network traffic flows of non-monitoring computing devices may not initially be associated with any application indicator. For example, application indicators 318b, 318c, and 318d may initially not be populated. However, with reference to FIG. 3B, the application indicators 318 for such traffic flows may be populated based on the information that identifies the source application of the particular traffic flow. Thus, application indicators 318e and 318f each indicate that the application “YouTube” is the source application of those respective network traffic flows. Further, application indicator 318g indicates that the application “Skype” is the source application of that particular network traffic flow.

FIGS. 4A, 4B, and 4C illustrate plots of various extrinsic traffic flow characteristics that may be observable within a first network traffic flow and a second network traffic flow. 1-4C, in various embodiments, the processor of a network device 102 may use the traffic flow characteristics to cluster network traffic flows. In various embodiments, traffic flow characteristics may include one or more of packet volumes, interarrival times, destination addresses, destination ports, packet lengths, and packet length densities. Traffic flow features may be used alone, or in combination, to characterize network traffic flows, and to cluster the network traffic flows.

FIGS. 4A, 4B, and 4C may enable a processor to distinguish a first service from second service, or relate two different traffic flows to one another based on observable traffic flow features.

FIG. 4A illustrates a plot of packet interarrival times for a first network traffic flow 402 of a first service, for example, a YouTube video, and a second network traffic flow 404 of a second service, for example, a Vimeo video. As shown in FIG. 4A, the two different services exhibit recognizably different interarrival time patterns. For example, the first network traffic 402 flow exhibits little variance in interarrival times, while the second network traffic 404 flow exhibits interarrival times ranging from a few seconds to over a minute. FIG. 4A also illustrates that a single observable traffic flow feature, such as packet interarrival time, may not distinguish or associate the first network traffic flow and the second network traffic flow sufficiently from/with one another. For example, an interarrival time of very few seconds is consistent with both the first and second traffic flows 402, 404.

However, when packet interarrival time and packet lengths are used together as network traffic features, the distinction may be more pronounced, as illustrated in FIG. 4B. Using interarrival times of packets with a packet length of 698 bytes or a packet length of 406 bytes separates the first network traffic flow from the second network traffic flow as shown in the comparison plots in FIG. 4B. Thus, using two traffic flow features (e.g., interarrival time and packet length) may enable traffic flows to be distinguished or related to one another.

As an alternate traffic flow feature, instead of interarrival times for a single packet size, the interarrivals for a range of packet sizes may be used. FIG. 4C illustrates comparison plots of packet densities that may be used as traffic flow features to associate or distinguish network traffic flows. Packet densities may be determined for packet lengths of different sizes, such as 522 bytes or 1474 bytes, and the relative densities of packets of that length may distinguish the first network traffic flow from the second network traffic flow, as the second network traffic flow may have a larger density of such packet sizes. Interarrival time, packet length, and packet densities are merely examples of traffic flow features that may be used to identify associated network traffic flows and any other traffic flow features may be used singularly, or in combination, in various embodiments to enable network traffic flows to be clustered together.

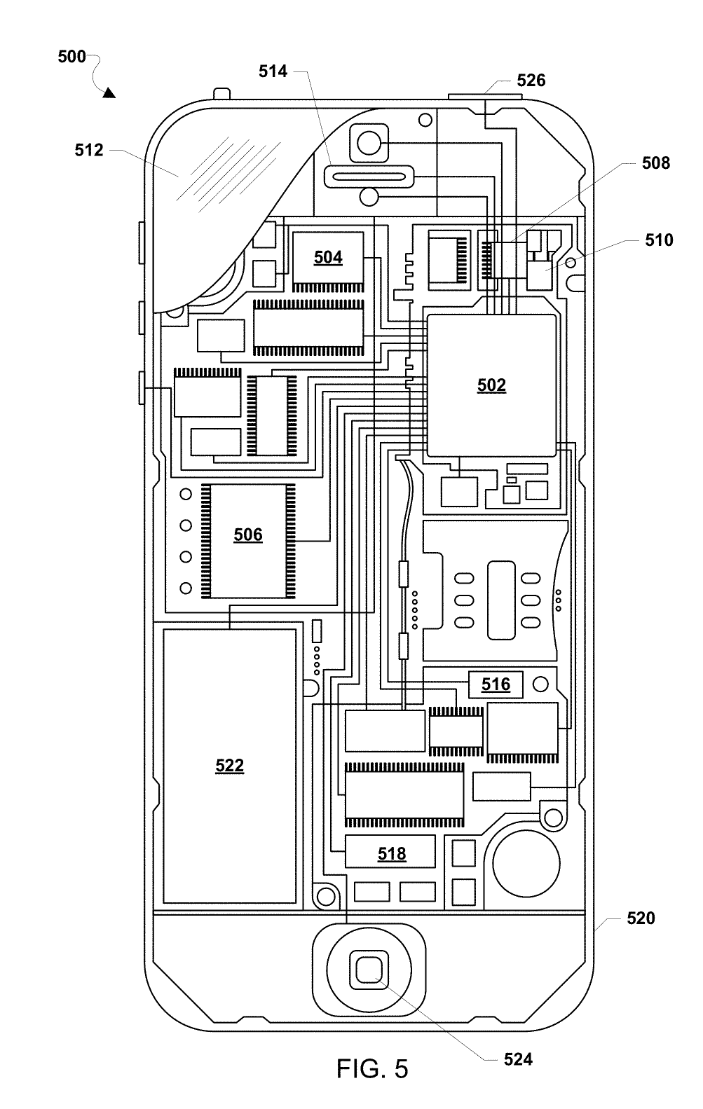

Various embodiments (including, but not limited to, embodiments described above with reference to FIGS. 1-4C) may be implemented in any of a variety of mobile computing devices, an example of which (e.g., mobile computing device 500) is illustrated in FIG. 5. With reference to FIGS. 1-5, the mobile computing device 500 may be similar to the computing devices 104-114, the network device 102, and the servers 116-120. As such, the mobile computing device 500 may implement the method 200 of FIG. 2A.

The mobile computing device 500 may include a processor 502 coupled to a touchscreen controller 504 and an internal memory 506. The processor 502 may be one or more multi-core integrated circuits designated for general or specific processing tasks. The internal memory 506 may be volatile or nonvolatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the mobile computing device 500 need not have touch screen capability.

The mobile computing device 500 may have two or more radio signal transceivers 508 (e.g., Peanut, Bluetooth, Zig Bee, Wi-Fi, etc.) and antennae 510, for sending and receiving communications, coupled to each other and/or to the processor 502. The transceivers 508 and antennae 510 may be used with the above-mentioned circuitry to implement the various wireless transmission protocol stacks and interfaces. The mobile computing device 500 may include one or more cellular network wireless modem chip(s) 516 coupled to the processor and antennae 510 that enable communication via two or more cellular networks via two or more radio access technologies.

The mobile computing device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The mobile computing device 500 may also include speakers 514 for providing audio outputs. The mobile computing device 500 may also include a housing 520, constructed of a plastic, metal, or a combination of materials, for containing all or some of the components discussed herein. The mobile computing device 500 may include a power source 522 coupled to the processor 502, such as a disposable or rechargeable battery. The rechargeable battery may also be coupled to the peripheral device connection port to receive a charging current from a source external to the mobile computing device 500. The mobile computing device 500 may also include a physical button 524 for receiving user inputs. The mobile computing device 500 may also include a power button 526 for turning the mobile computing device 500 on and off.

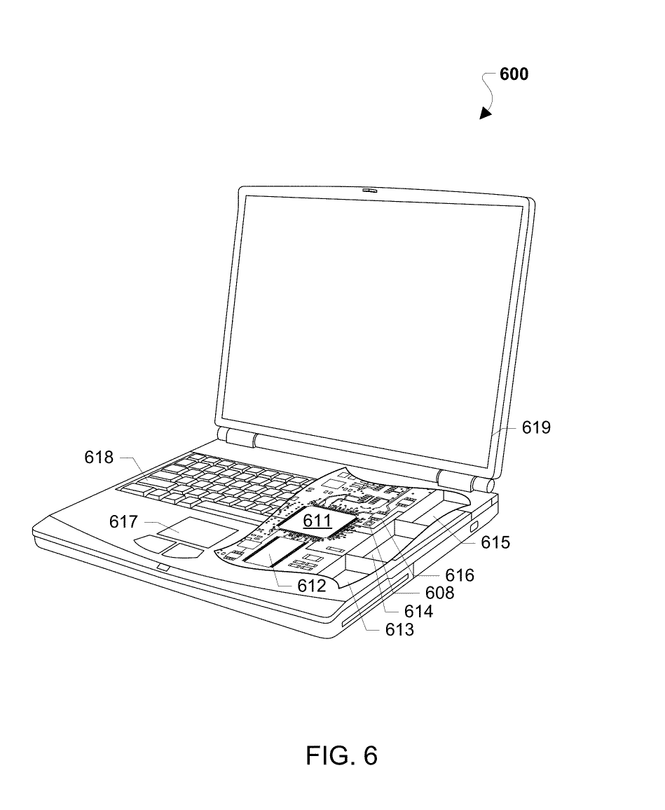

Various embodiments (including, but not limited to, embodiments described above with reference to FIGS. 1-4C) may be implemented in a wide variety of computing devices include a laptop computer 600 an example of which is illustrated in FIG. 6. With reference to FIGS. 1-6, the laptop computer 600 may be similar to the computing devices 104-114, the network device 102, and the servers 116-120. As such, the laptop computer 600 may implement the method 200.

Many laptop computers include a touchpad touch surface 617 that serves as the computer's pointing device, and thus may receive drag, scroll, and flick gestures similar to those implemented on computing devices equipped with a touch screen display and described above. A laptop computer 600 will typically include a processor 611 coupled to volatile memory 612 and a large capacity nonvolatile memory, such as a disk drive 613 of Flash memory. Additionally, the computer 600 may have one or more antenna 608 for sending and receiving electromagnetic radiation that may be connected to a wireless data link and/or cellular telephone transceiver 616 coupled to the processor 611. The computer 600 may also include a floppy disc drive 614 and a compact disc (CD) drive 615 coupled to the processor 611. In a notebook configuration, the computer housing includes the touchpad 617, the keyboard 618, and the display 619 all coupled to the processor 611. Other configurations of the computing device may include a computer mouse or trackball coupled to the processor (e.g., via a Universal Serial Bus (USB) input) as are well known, which may also be used in conjunction with various embodiments.

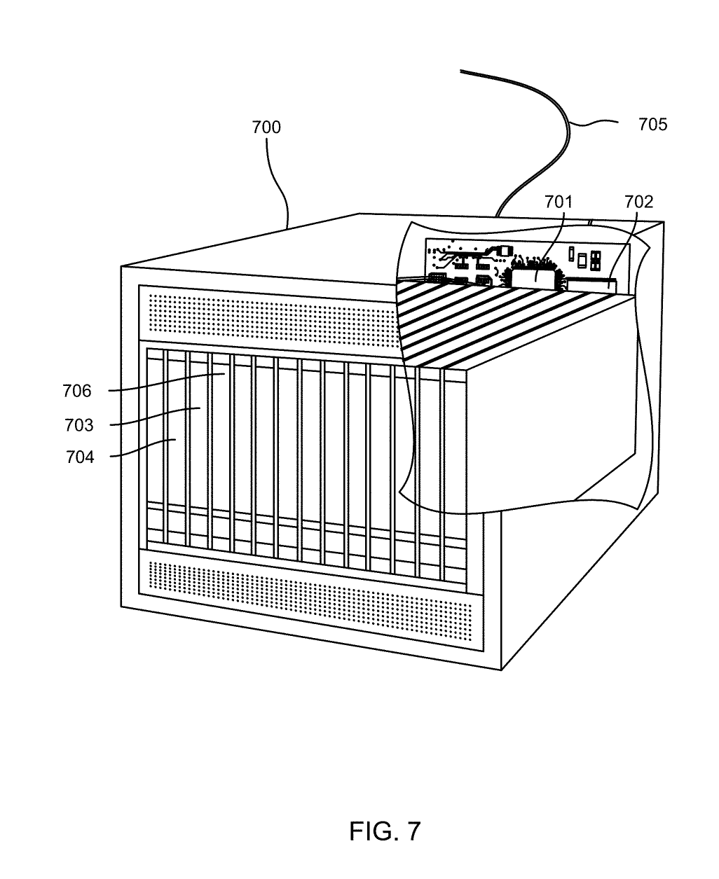

Various embodiments (including, but not limited to, embodiments described above with reference to FIGS. 1-4C) may also be implemented on any of a variety of commercially available server devices, such as the server 700 illustrated in FIG. 7. With reference to FIGS. 1-7, the server 700 may be similar to the computing devices 104-114, the network device 102, and the servers 116-120 described with reference to FIG. 1. As such, the server 700 may implement the method 200 of FIG. 2A.

Such a server 700 typically includes a processor 701 coupled to volatile memory 702 and a large capacity nonvolatile memory, such as a disk drive 704. The server 700 may also include a floppy disc drive, compact disc (CD) or DVD disc drive 706 coupled to the processor 701. The server 700 may also include one or more network transceivers 703, such as a network access port, coupled to the processor 701 for establishing network interface connections with a communication network 705, such as a local area network coupled to other announcement system computers and servers, the Internet, the public switched telephone network, and/or a cellular network (e.g., CDMA, TDMA, GSM, PCS, 3G, 4G, LTE, or any other type of cellular network).

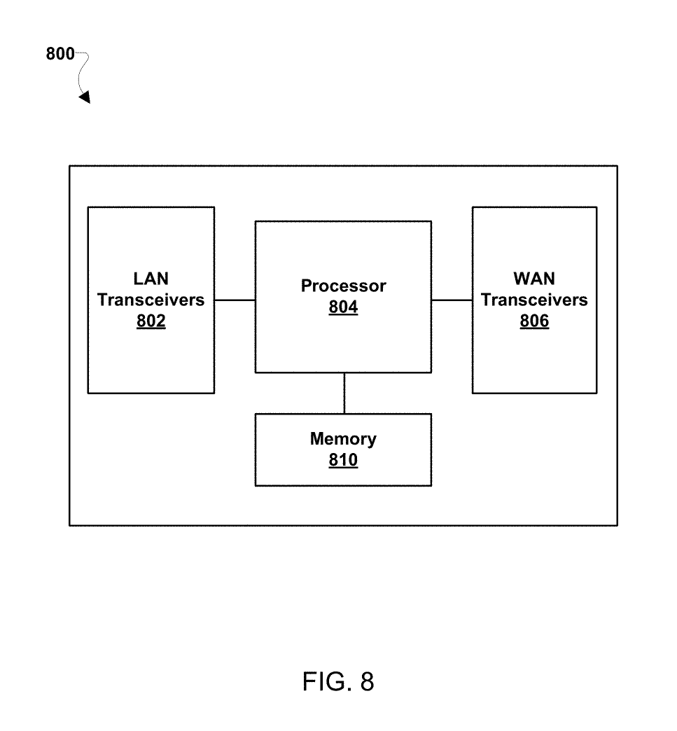

Various embodiments (including, but not limited to, embodiments described above with reference to FIGS. 1-4C) may also be implemented on any of a variety of commercially available network devices, such as routers, etc., such as the network device 800 illustrated in FIG. 8. In various embodiments, the network device 800 may be similar to the computing devices 104-114, the network device 102, and the servers 116-120 described with reference to FIG. 1. As such, the network device 800 may implement the method 200 of FIG. 2A.

With reference to FIGS. 1-8, such a network device 800 typically includes a processor 804 coupled to one or more memory 810, such as a volatile and/or nonvolatile memory. The network device 800 may also include one or more LAN transceivers 802, such as a wired or wireless network access port, coupled to the processor 804 for establishing LAN interface connections with connected computing devices. The network device 800 may also include one or more WAN transceivers 806, such as a wired or wireless network access port, coupled to the processor 804 for establishing WAN interface connections with a communication network, such as the Internet, the public switched telephone network, and/or a cellular network (e.g., CDMA, TDMA, GSM, PCS, 3G, 4G, LTE, or any other type of cellular network).

The processors described herein, such as processors 502, 611, 701, and/or 804, may be any programmable microprocessor, microcomputer or multiple processor chip or chips that can be configured by software instructions (applications) to perform a variety of functions, including the functions of various embodiments described below. In devices, multiple processors 502, 611, 701, and/or 804 may be provided, such as one processor dedicated to wireless communication functions and one processor dedicated to running other applications. Typically, software applications may be stored in the internal memory before they are accessed and loaded into the processors 502, 611, 701, and/or 804. The processors 502, 611, 701, and/or 804 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of identifying compromised applications executing in computing devices within a network, comprising:
monitoring, by a processor of a network device, network traffic flows to identify characteristics of the network traffic flows;
identifying, by the processor of the network device, a source application that is a source of at least some of the network traffic flows by comparing the identified characteristics of the network traffic flows to network flow characteristics that have been determined to be associated with the identified source application;
determining, by the processor of the network device, whether characteristics of network traffic flows identified as related to the source application match or are consistent with normal characteristics of network traffic flows associated with the identified source application; and
determining, by the processor of the network device, that the identified source application is anomalous in response to determining that characteristics of the network traffic flows identified as related to the identified source application do not match or are inconsistent with the normal characteristics of network traffic flows of the identified source application.

2. The method of claim 1, further comprising determining network flow characteristics associated with the identified source application by:
receiving, in the processor of the network device, a first network traffic flow of a monitoring computing device and a source application tag or other information identifying an application that is a source of the first network traffic flow; and
determining, in the processor of the network device, one or more network flow characteristics that are associated with the identified source application of the first network traffic flow.

3. The method of claim 2, further comprising:
receiving, in the processor of the network device, a second network traffic flow from a non-monitoring computing device;
determining, by the processor of the network device, a source application of the second network traffic flow by comparing characteristics of the second network traffic flow to the one or more network flow characteristics of the first network traffic flow determined to be associated with the source application; and
determining, by the processor of the network device, normal characteristics of the source application by observing over a period of time network traffic flows having characteristics matching or corresponding to the one or more network flow characteristics associated with the identified source application.

4. The method of claim 3, further comprising:
clustering, by the processor of the network device, network traffic flows based on characteristics of the network traffic flows matching or corresponding to the network flow characteristics associated with the identified source application.

5. The method of claim 2, wherein the characteristics of the network traffic flows include information in packet headers of the network traffic flows.

6. The method of claim 2, wherein the characteristics of the network traffic flows include one or more traffic features of the network traffic flows.

7. The method of claim 1, further comprising:
determining network flow characteristics associated with the identified source application; and
learning, by a semi-supervised application of the network device, associations of a source application tag with the network flow characteristics.

8. The method of claim 1, wherein identifying the source application that is the source of at least some of the network traffic flows by comparing the identified characteristics of the network traffic flows to network flow characteristics that have been determined to be associated with the identified source application comprises:
comparing, by the processor of the network device, packet header information of the network traffic flows with packet header information associated with the source application;
determining, by the processor of the network device, whether the packet header information of one or more of the network traffic flows matches or correlates to the packet header information associated with the source application; and
associating, by the processor of the network device, the source application with one or more of the network traffic flows in response to determining that the packet header information of the one or more of the network traffic flows matches or correlates to the packet header information associated with the source application.

9. The method of claim 1, wherein identifying the source application of at least some of the network traffic flows by comparing the identified characteristics of the network traffic flows to network flow characteristics that have been determined to be associated with the identified source application comprises:
comparing, by the processor of the network device, a traffic feature of the network traffic flows with a traffic feature associated with the source application;
determining, by the processor of the network device, whether the traffic feature of one or more of the network traffic flows matches or correlates to the traffic feature associated with the source application; and
associating, by the processor of the network device, the source application with one or more of the network traffic flows in response to determining that the traffic feature of the one or more of the network traffic flows matches or correlates to the traffic feature associated with the source application.

10. The method of claim 1, wherein identifying the source application that is the source of at least some of the network traffic flows by comparing the identified characteristics of the network traffic flows to network flow characteristics associated with the identified source application comprises:
comparing, by the processor of the network device, packet header information of the network traffic flows with packet header information associated with the source application;
comparing, by the processor of the network device, one or more traffic features of the network traffic flows with one or more traffic features associated with the source application;
determining, by the processor of the network device, whether the packet header information and the one or more traffic features of the network traffic flows correlate to the packet header information and the one or more traffic features associated with the source application within a threshold degree of correlation; and
associating, by the processor of the network device, the source application with one or more of the network traffic flows in response to determining that the packet header information and the one or more traffic features of the network traffic flows correlate to the packet header information and the one or more traffic features associated with the source application within the threshold degree of correlation.

11. A network device, comprising:
a processor configured with processor-executable instructions to:
monitor network traffic flows to identify characteristics of the network traffic flows;
identify a source application that is a source of at least some of the network traffic flows by comparing the identified characteristics of the network traffic flows to network flow characteristics that have been determined to be associated with the identified source application;
determine whether characteristics of network traffic flows identified as related to the source application match or are consistent with normal characteristics of network traffic flows associated with the identified source application; and
determine that the identified source application is anomalous in response to determining that characteristics of the network traffic flows identified as related to the identified source application do not match or are inconsistent with the normal characteristics of network traffic flows of the identified source application.

12. The network device of claim 11, wherein the processor is further configured to:
receive a first network traffic flow of a monitoring computing device and a source application tag or other information identifying an application that is a source of the first network traffic flow; and
determine one or more network flow characteristics that are associated with the identified source application of the first network traffic flow.

13. The network device of claim 12, wherein the processor is further configured to:
receive a second network traffic flow from a non-monitoring computing device;
determine a source application of the second network traffic flow by comparing characteristics of the second network traffic flow to the one or more network flow characteristics of the first network traffic flow determined to be associated with the source application; and
determine normal characteristics of the source application by observing over a period of time network traffic flows having characteristics matching or corresponding to the one or more network flow characteristics associated with the identified source application.

14. The network device of claim 13, wherein the processor is further configured to:
cluster network traffic flows based on characteristics of the network traffic flows matching or corresponding to the network flow characteristics associated with the identified source application.

15. The network device of claim 12, wherein the processor is further configured such that the characteristics of the network traffic flows include information in packet headers of the network traffic flows.

16. The network device of claim 12, wherein the processor is further configured such that the characteristics of the network traffic flows include one or more traffic features of the network traffic flows.

17. The network device of claim 11, wherein the processor is further configured to:
determining network flow characteristics associated with the identified source application; and
learn associations of a source application tag with the network flow characteristics.

18. The network device of claim 11, wherein the processor is further configured to:
compare packet header information of the network traffic flows with packet header information associated with the source application;
determine whether the packet header information of one or more of the network traffic flows matches or correlates to the packet header information associated with the source application; and
associate the source application with one or more of the network traffic flows in response to determining that the packet header information of the one or more of the network traffic flows matches or correlates to the packet header information associated with the source application.

19. The network device of claim 11, wherein the processor is further configured to:
compare a traffic feature of the network traffic flows with a traffic feature associated with the source application;
determine whether the traffic feature of one or more of the network traffic flows matches or correlates to the traffic feature associated with source application; and
associate the source application with one or more of the network traffic flows in response to determining that the traffic feature of the one or more of the network traffic flows matches or correlates to the traffic feature associated with the source application.

20. The network device of claim 11, wherein the processor is further configured to:
compare packet header information of the network traffic flows with packet header information associated with the source application;
compare one or more traffic features of the network traffic flows with one or more traffic features associated with the source application;
determine whether the packet header information and the one or more traffic features of the network traffic flows correlate to the packet header information and the one or more traffic features associated with the source application within a threshold degree of correlation; and
associate the source application with one or more of the network traffic flows in response to determining that the packet header information and the one or more traffic features of the network traffic flows correlate to the packet header information and the one or more traffic features associated with the source application within the threshold degree of correlation.

21. A network device, comprising:
means for monitoring network traffic flows to identify characteristics of the network traffic flows;
means for identifying a source application that is a source of at least some of the network traffic flows by comparing the identified characteristics of the network traffic flows to network flow characteristics that have been determined to be associated with the identified source application;
means for determining whether characteristics of network traffic flows identified as related to the source application match or are consistent with normal characteristics of network traffic flows associated with the identified source application; and
means for determining that the identified source application is anomalous in response to determining that characteristics of the network traffic flows identified as related to the identified source application do not match or are inconsistent with the normal characteristics of network traffic flows of the identified source application.

22. A non-transitory processor readable storage medium having stored thereon processor-executable instructions configured to cause a processor of a network element to perform operations comprising:
monitoring network traffic flows to identify characteristics of the network traffic flows;
identifying a source application that is a source of at least some of the network traffic flows by comparing the identified characteristics of the network traffic flows to network flow characteristics that have been determined to be associated with the identified source application;
determining whether characteristics of network traffic flows identified as related to the source application match or are consistent with normal characteristics of network traffic flows associated with the identified source application; and
determining that the identified source application is anomalous in response to determining that characteristics of the network traffic flows identified as related to the identified source application do not match or are inconsistent with the normal characteristics of network traffic flows of the identified source application.

23. The non-transitory processor readable storage medium of claim 22, wherein the stored processor-executable instructions are configured to cause the processor of the network element to perform operations further comprising:
receiving a first network traffic flow of a monitoring computing device and a source application tag or other information identifying an application that is a source of the first network traffic flow; and
determining one or more network flow characteristics that are associated with the identified source application of the first network traffic flow.

24. The non-transitory processor readable storage medium of claim 23, wherein the stored processor-executable instructions are configured to cause the processor of the network element to perform operations further comprising:
receiving a second network traffic flow from a non-monitoring computing device;
determining a source application of the second network traffic flow by comparing characteristics of the second network traffic flow to the one or more network flow characteristics of the first network traffic flow determined to be associated with the source application; and
determining normal characteristics of the source application by observing over a period of time network traffic flows having characteristics matching or corresponding to the one or more network flow characteristics associated with the identified source application.

25. The non-transitory processor readable storage medium of claim 24, wherein the stored processor-executable instructions are configured to cause the processor of the network element to perform operations further comprising:
clustering network traffic flows matching or corresponding to the network flow characteristics associated with the identified source application.

26. The non-transitory processor readable storage medium of claim 23, wherein the stored processor-executable instructions are configured to cause the processor of the network element to perform operations such that the characteristics of the network traffic flows include information in packet headers of the network traffic flows.

27. The non-transitory processor readable storage medium of claim 23, wherein the stored processor-executable instructions are configured to cause the processor of the network element to perform operations such that the characteristics of the network traffic flows include one or more traffic features of the network traffic flows.

28. The non-transitory processor readable storage medium of claim 23, wherein the stored processor-executable instructions are configured to cause the processor of the network element to perform operations such that determining one or more characteristics of the first network traffic flow associated with the source application of the first network traffic flow comprises:
determining network flow characteristics associated with the identified source application; and
learning, by a semi-supervised application of the network device, associations of a source application tag with the network flow characteristics.

29. The non-transitory processor readable storage medium of claim 22, wherein the stored processor-executable instructions are configured to cause the processor of the network element to perform operations such that identifying the source application that is a source of at least some of the network traffic flows by comparing the identified characteristics of the network traffic flows to network flow characteristics that have been determined to be associated with the identified source application comprises:
comparing packet header information of the network traffic flows with packet header information associated with the source application;
determining whether the packet header information of one or more of the network traffic flows matches or correlates to the packet header information associated with the source application; and
associating the source application with one or more of the network traffic flows in response to determining that the packet header information of the one or more of the network traffic flows matches or correlates to the packet header information associated with the source application.

30. The non-transitory processor readable storage medium of claim 22, wherein the stored processor-executable instructions are configured to cause the processor of the network element to perform operations such that identifying the source application of at least some of the network traffic flows by comparing the identified characteristics of the network traffic flows to network flow characteristics associated with the identified source application comprises:
comparing a traffic feature of the network traffic flows with a traffic feature associated with the source application;
determining whether the traffic feature of one or more of the network traffic flows matches or correlates to the traffic feature associated with the source application; and
associating the source application with one or more of the network traffic flows in response to determining that the traffic feature of the one or more of the network traffic flows matches or correlates to the traffic feature associated with the source application.
